(19) United States
(12) Patent Application Publication
(10) Pub. No.: US 2013/0297877 A1
(43) Pub. Date: Nov. 7, 2013

(54) MANAGING BUFFER MEMORY

(71) Applicant: Jack B. Dennis, Cambridge, MA (US)

(72) Inventor: Jack B. Dennis, Cambridge, MA (US)

(21) Appl. No.: 13/874,572

(22) Filed: May 1, 2013

Related U.S. Application Data
(60) Provisional application No. 61/641,555, filed on May 2, 2012.

(51) Int. Cl. G06F 12/08

(52) U.S. Cl. CPC G06F 12/0811
USPC 711/122

(57) ABSTRACT

A computing system comprises: one or more processors; and a memory system including one or more first level memories. Each first level memory is coupled to a corresponding one of the processors. Each processor is configured to execute instructions in an instruction set, at least some of the instructions in the instruction set accessing chunks of memory in the memory system. Each processor includes a plurality of storage locations, with at least some of the instructions each specifying a set of storage locations including: a first storage location in a first of the processors storing a unique identifier of a first chunk, and a second storage location in the first processor storing a reusable identifier of a storage area in the corresponding first level memory storing the first chunk.

### CROSS-REFERENCE TO RELATED APPLICATIONS

This application claims the benefit of U.S. Provisional Application No. 61/641,555, titled “CACHE MEMORY ALTERNATIVE,” filed May 2, 2012, incorporated herein by reference.

### STATEMENT AS TO FEDERALLY SPONSORED RESEARCH

This invention was made with government support under CCF-0937907 awarded by the National Science Foundation. The government has certain rights in the invention.

### BACKGROUND

This invention relates to an approach to managing buffer memory (e.g., as an alternative to techniques for managing conventional cache memory).

In the architecture of many-core processing chips there is a bias against using conventional cache memory due to their complexity and the energy required to operate them. Instead, designers have advocated that the programmer manage transfer of data between memory levels so as to ensure that the data needed in the current stage of a computation is present in the appropriate level of the memory system. In the multi-core era, this typically means replacing the per core L1 cache and the shared on-chip L2 cache with program managed data buffers. Moving to programmer management of the memory resource may lead to a sacrifice of some positive benefits of system managed resources such as modularity, resilience, and portability of application software. Even energy efficiency may be sacrificed due to the energy consumed in execution of the extra instructions used to perform memory management.

### SUMMARY

An alternative hardware architecture achieves the benefits of system managed resources, but requires less area and power than conventional cache memories. This alternative includes use of a set of buffer memories and a model of a linear address space using a tree structure in the manner explained herein.

The approach has application in a variety of computer system architectures, including one in which memory is viewed as a collection of fixed-size chunks, and can also be useful in systems that implement a conventional linear virtual address space.

In one aspect, in general, a computer processor includes an instruction processor configured to execute instructions in an instruction set. At least some of the instructions in the instruction set access chunks of memory in a memory system coupled to the computer processor. The computer processor also includes a plurality of storage locations, with at least some of the instructions each specifying a set of storage locations including: a first storage location storing a unique identifier of a first chunk, and a second storage location storing a reusable identifier of a storage area in the memory system storing the first chunk.

Aspects can include one or more of the following features.

The plurality of storage locations comprise a first set of registers configured to store unique identifiers of chunks and a second set of registers configured to store reusable identifiers of storage areas storing chunks identified by the unique identifiers stored in the first set of registers, and wherein for at least some of the instructions, the first storage location comprises one of the plurality of registers of the first set, and the second storage location comprises one of the plurality of registers of the second set.

Each register of the first set is associated with a tag that has at least two states, including at least one state that identifies that register as storing a unique identifier of a chunk, and at least one state that identifies that register as storing a data value.

Each register of the second set is associated with a flag that identifies that register as storing a reusable identifier of a storage area that is currently storing a chunk identified by a unique identifier stored in a corresponding register in the first set.

The storage area is a storage area in a first memory level of the memory system.

The memory system includes the first memory level and a second memory level, the first memory level being configured as a buffer for chunks stored in the second memory level.

The storage area is one of a plurality of storage areas in the memory system.

The memory system includes control circuitry configured to assign a particular reusable identifier, from a set of reusable identifiers that have a one-to-one correspondence with the plurality of storage areas, to different unique identifiers based on which chunks are stored in the storage area corresponding to that particular reusable identifier.

The instruction set includes memory instructions for accessing chunks of memory, each including: a first field specifying a set of storage locations including a storage location storing a unique identifier of a chunk; and a second field specifying an element of the chunk identified by the unique identifier stored in a storage location specified by the first field.

In another aspect, in general, a memory system includes one or more memory levels, each memory level comprising storage areas for a plurality of chunks of memory. The memory system is configured to be responsive to memory messages in a message set from a processor coupled to the memory system. At least some of the messages include: a first field identifying a unique identifier of a first chunk stored in a storage area of a first memory level of the memory system, and a second field identifying a reusable identifier of the storage area.

Aspects can include one or more of the following features.

The memory system includes control circuitry configured to search for a second chunk in a second memory level in response to the second storage location in the processor being tagged as not storing a valid reusable identifier of a storage area of the first memory level currently storing the second chunk.

The memory system is configured to maintain a linkage among a plurality of chunks via unique identifiers stored in elements of the chunks.

The memory system includes the first memory level and a second memory level, the first memory level being configured as a buffer for chunks stored in the second memory level.

The storage area is one of a plurality of storage areas of the first memory level of the memory system.

The memory system includes control circuitry configured to assign a particular reusable identifier, from a set of reusable identifiers that have a one-to-one correspondence with the plurality of storage areas, to different unique identifiers based on which chunks are stored in the storage area corresponding to that particular reusable identifier.

In another aspect, in general, a computing system includes: one or more processors; and a memory system including one or more first level memories, each first level memory coupled to a corresponding one of the processors. Each processor is configured to execute instructions in an instruction set, at least some of the instructions in the instruction set accessing chunks of memory in the memory system, and each processor includes a plurality of storage locations. At least some of the instructions each specify a set of storage locations including: a first storage location in a first of the processors storing a unique identifier of a first chunk, and a second storage location in the first processor storing a reusable identifier of a storage area in the corresponding first level memory storing the first chunk.

Aspects can include one or more of the following features.

Each of the first level memories includes storage areas for one or more chunks, each chunk having the same number of elements, each element being configured for storing either a unique identifier of a chunk or a data value. The memory system is configured to be responsive to memory messages in a message set from the processors. At least some of the messages include: a first field including a unique identifier of a chunk, and a second field including a reusable identifier of a storage area storing the chunk identified by the unique identifier.

At least some of the messages further include a third field including a memory address specifying a data element in an address space of the memory system.

At least some of the instructions each include: a first field specifying the set of storage locations including the first storage location and the second storage location, and a second field including a memory address specifying a data element in the address space.

The address space includes a plurality of distinct address space pages, each page corresponding to a chunk, and each page having the same number of elements as the number of elements in a chunk, and each element of a page being configured for storing either a unique identifier of a chunk or a data value.

A memory address included in the third field of a message or the second field of an instruction is represented as a first sequence of address nibbles, a second sequence of address nibbles forms an address prefix that includes all address nibbles in the first sequence except for the last address nibble in the first sequence, and the last address nibble in the first sequence comprises a chunk offset identifying an element of a chunk.

An address nibble includes a sufficient set of bits to uniquely select an element of a chunk.

Each first level memory includes control circuitry configured to store associations of members of a set of one or more memory keys with members of a set of reusable identifiers of memory storage areas, and each memory key includes at least a first field including a first buffer index of a storage area, and a second field including a sequence of two or more address nibbles of the memory address.

The address nibbles of the memory address except for the last nibble of the sequence together select a page in the address space storing the chunk identified by the unique identifier stored in a storage location specified by the first field, and the last nibble of the sequence comprises a chunk offset identifying an element of the chunk stored in the page.

At least some of the instructions each include: a first field specifying a set of storage locations including a storage location storing a unique identifier of a chunk, and a second field specifying an element of the chunk identified by the unique identifier stored in a storage location specified by the first field.

The plurality of storage locations in each of the processors comprises a first set of registers configured to store unique identifiers of chunks and a second set of registers configured to store reusable identifiers of storage areas storing chunks identified by the unique identifiers stored in the first set of registers, and wherein for at least some of the instructions, the first storage location comprises one of the plurality of registers of the first set, and the second storage location comprises one of the plurality of registers of the second set.

In another aspect, in general, data stored on a non-transitory computer-readable medium comprises instructions (e.g., Verilog) for causing a circuit design system to form a circuit description for a processor and/or a memory system as described above.

Other features and advantages of the invention are apparent from the following description, and from the claims.

### DESCRIPTION OF DRAWINGS

FIG. 1 is a block diagram of a computing system.

FIG. 2 is a block diagram of an associative index map.

FIG. 3 is a block diagram of a non-register buffering system.

FIG. 4 is a block diagram of a linear address space buffering system.

### DESCRIPTION

In one example of a memory model used by a computer system, information objects and data structures are represented using fixed size chunks of memory, for example, 128 bytes (i.e., 128*8=1024 bits). Each chunk of memory is able to represent a fixed number of fixed size chunk elements, for example, 16 chunk elements that are each 64 bits long (i.e., 16*64=1024 bits). Each chunk has a unique identifier, its handle, that serves to locate the chunk within the memory hierarchy of the computer system, and is a globally valid means of reference to the chunk. In the following examples, the handle is a 64-bit identifier, and each chunk holds up to 16 chunk elements that are each tagged as being either a 64-bit data value or a 64-bit handle of another chunk. While the handle is able to serve as a permanent identifier of a particular chunk of memory, it is also useful to provide a temporary identifier of a current storage location of that particular chunk of memory in a set of chunk buffers in a first level of a memory system, as described in more detail below. The temporary identifier can be one of a set of reusable identifiers, such as a set of consecutive index values that have a one-to-one correspondence with the chunk buffers. Memory instructions that access a chunk can use both the unique handle and the reusable index to provide an efficient and reliable way to access the chunk. If the chunk is currently buffered, then the index is sufficient to find the chunk, but if the chunk is not currently buffered, then the handle enables the system to search for the chunk in other levels of the memory system.

A collection of chunks organized as a directed acyclic graph (DAG), with chunks as nodes of the DAG and handles as links of the DAG (directed from the chunk storing the handle to the chunk identified by the handle), can represent structured information. For example, a three-level tree of chunks can represent an array of up to 4096 elements (assuming a balanced arrangement of chunks) with one chunk at the root level, 16 chunks at the middle level, and 256 chunks at the lowest level (the leaves of the tree) storing 4096 data values representing the elements of the array. A variety of data objects and data structures may be represented by unbounded trees of chunks.

Consider a computer processor executing a sequential program with this memory model. The processor includes a set of general purpose registers that can store either data values or the handles of chunks. Each register may also be associated with a corresponding tag that includes bits indicating various conditions of content stored in the register, including a bit that indicates whether the content of the register is valid (i.e., storing loaded content) or invalid (i.e., any stored content is old or not currently in use). The tag also includes a bit that indicates whether the (valid) content of a register is a data value or a handle.

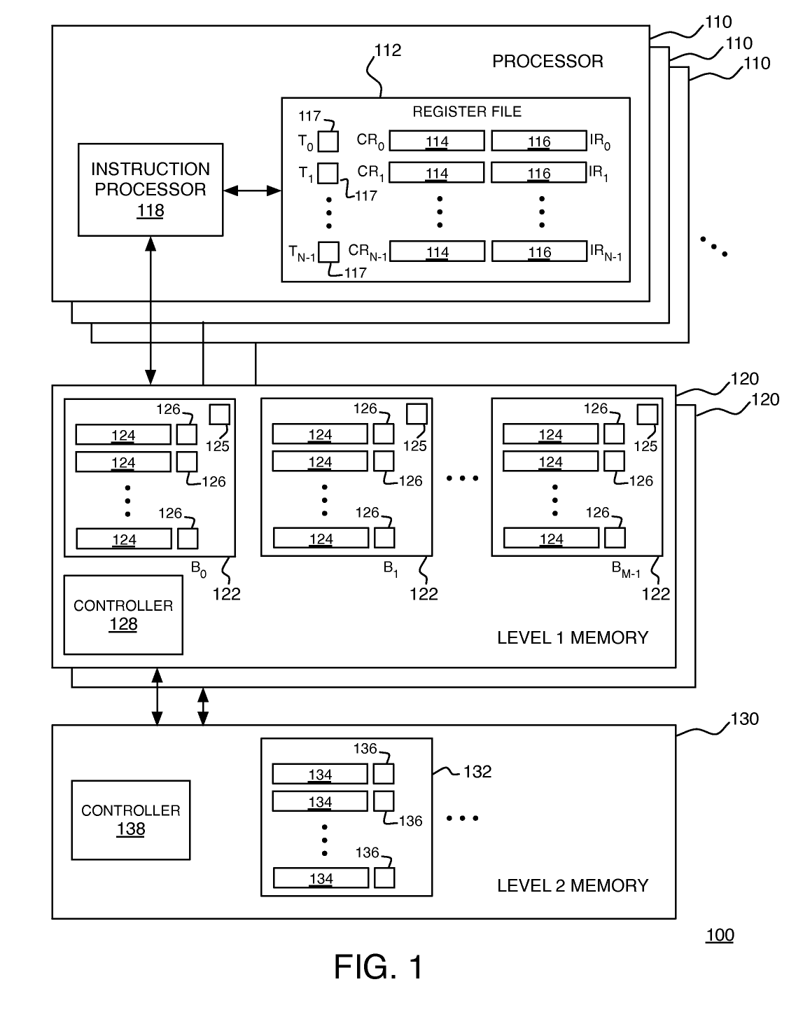

Referring to FIG. 1, an example implementation of a multiple processor computing system 100 makes use of such a chunk approach introduced above. One or more processors 110 (e.g., processor cores of a multi-core processor) each include an instruction processor 118 and a register file 112 (other elements of the processor 110 are omitted in this figure for clarity). The register file 112 includes a set of N chunk element (CE) registers 114 (labeled CR₀-CR_{N-1}), and a set of N index registers 116 (labeled IR₀-IR_{N-1}), with each CE register 114 being associated with a corresponding index register 116. There is also a set of N tags 117 (labeled T₀-T_{N-1}), each associated with a corresponding pair of registers: a CE register 114 and an index register 116. Some of the bits in a tag 117 are validity bits, with one validity bit indicating whether the content of the CE register 114 is valid, and one validity bit indicating whether the content of the index register 116 is valid. In this example, each CE register 114 can store either a 64-bit data value or a 64-bit handle to a chunk, and if the validity bit for the CE register is valid, a content bit in the tag 117 indicates whether the content is a data value or a handle. If the CE register 114 stores a data value, the index register 116 associated with that CE register 114 is tagged as invalid. If the CE register 114 stores a handle, the index register 116 associated with the CE register 114 is tagged as valid and stores an index value that identifies a particular storage area that stores the chunk specified by the handle stored in the CE register 114, as described in more detail below.

Each processor 110 is coupled to at least one level of memory. In this example, each processor 110 is coupled to a level 1 memory 120 in a one-to-one arrangement (e.g., a per core L1 cache), but it should be understood that multiple processors could share the same memory (e.g., a shared on-chip L2 cache), and that the level 1 memory 120 could serve as a buffer for data from another level of memory without necessarily being part of a conventional hierarchical cache system. As illustrated in FIG. 1, the system 100 includes multiple levels of memory, shown as a representative level 2 memory 130. For example, the level 2 memory 130 may serve as a backing store of much larger storage capacity for storing chunks that are buffered in the level 1 memory 120. Chunks may be created in the level 1 memory 120, moved to the level 2 memory 130 after they are no longer in use, and then moved back to the level 1 memory 120 from the level 2 memory 130 when they are needed again, for example. The memories may be implemented in various technologies of solid state memory, and at the levels furthest from the processors using magnetic (e.g., disk) memory systems. In some implementations, each level of memory includes a controller, which may be implemented using logic to handle the messages from higher and lower levels. For example, the level 1 memory 120 includes a controller 128, and the level 2 memory includes a controller 138.

The level 1 memory 120, and more generally, multiple levels of memory are arranged to store data as chunks. For example, the level 1 memory 120 has a number of storage areas called chunk buffers 122 (organized as M blocks of memory that serve as buffers for storing chunks, labeled B₀-B_{M-1}), with each chunk stored in one of the chunk buffers 122 having 16 chunk elements 124, each for holding either a 64-bit data value or a handle to another chunk. Associated with each chunk buffer 122 is a free flag 125 that indicates whether that chunk buffer 122 is available or in use. Optionally, in some implementations, associated with each chunk element 124 in a buffered chunk is an index field 126, whose function is described more fully below. The level 2 memory 130, which is coupled to the level 1 memory 120, similarly has storage areas 132 for storing chunks, each with the same structure as the chunk storage areas 122 in the level 1 memory, with each stored chunk having 16 chunk elements 134, and optionally, an index field 136. The level 1 controller 128 is configured to perform a replacement procedure to select one of the chunk buffers 122 to store a newly loaded chunk. An available chunk buffer 122 is selected (as indicated by the free flags 125), or if all chunk buffers are in use, one of the chunk buffers in use (e.g., a least recently used chunk buffer storing a read-only chunk) is selected to have its content replaced with the newly loaded chunk.

The instruction processor 118 is configured to execute instructions from an instruction set that includes the following instructions for operating on chunks:
Handle ChunkCreate( ) This instruction creates a new chunk in the memory system and return its handle.
void ChunkWrite(Handle h, int offset, Word w), and void ChunkWrite(Handle h, int offset, Handle k) This instruction writes the data value w (a 64-bit word) or handle k to the chunk element at position offset (an integer from 0-15, which may be encoded in a 4-bit nibble) in the chunk specified by h and set the tag of the chunk element accordingly to indicate that either a data value or a handle was written.
Word ChunkRead(Handle h, int offset), and Handle ChunkRead(Handle h, int offset) This instruction returns the data value (a 64-bit word) or handle, at position offset in the chunk specified by handle h. If the element has never been written or is of the wrong kind (as indicated by its tag), the processor reports an error and aborts program execution.
void ChunkSeal(Handle h) This instruction seals the chunk specified by handle h.

For instructions that specify a handle, that handle is referenced using an index (e.g., a value from 0 to N-1) that selects a pair of registers in the register file 112: a CE register 114 and a corresponding index register 116. The index also selects a corresponding tag 117, which includes validity bits for the selected registers. For instructions that specify an offset, that offset may be provided directly as a literal value within a field of the instruction, or may be referenced using another index that selects another register, for example. The offset is used to select one of the (16) chunk elements of the chunk uniquely identified by the referenced handle.

Each of these instructions corresponds to a message exchange between the processor 110 and the level 1 memory 120. These instructions conform to a write-once memory model, where the chunks may be created and written by a task of a program, but access to a chunk is not permitted to another task of the program until it is “sealed” using a ChunkSeal instruction, which renders the chunk read-only. Subsequent attempts to write elements of the chunk after it has been sealed are invalid until the chunk is deallocated (e.g., after the operating system determines that no references to the chunk remain in a program). A deallocated chunk is then available to be allocated for use in response to a ChunkCreate instruction. Examples of usage of these instructions are as follows.

In response to a ChunkCreate instruction, one of the chunk buffers 122 in the level 1 memory 120 is made available for writing data values or handles into the chunk elements of the newly created chunk, and both the handle of the newly created chunk and the index for that chunk buffer 122 in the level 1 memory are passed back to the processor 120. A program running on the processor 110 may store the handle in one of the CE registers 114, and the index of the chunk buffer 122 within the level 1 memory in the corresponding index register 116 for that CE register 114.

As another example, suppose that two chunks are created, with their handles h1 and h2 stored in CE registers CR₀ and CR₁, respectively. The second chunk (with handle h2) may be linked to first chunk (with handle h1), for example, by writing its handle h2 into the chunk element at offset 3 with the instruction ChunkWrite(h1,3,h2), where the values h1 and h2 are provided from registers, and therefore are verified in hardware to be valid handles. Furthermore, the message passed from the processor to the level 1 memory 120 includes a reference to the index register IR₀ associated with the CE register CR₀ to locate the chunk buffer in which the first chunk is currently being stored, so that the ChunkWrite instruction can write h2 into the chunk element at offset 3 within that chunk buffer. Since no chunk elements of the second chunk are read or written by the ChunkWrite instruction, the message does not necessarily need to include a reference to the index register IR₁ associated with the CE register CR₁, which would be used to locate the chunk buffer in which the second chunk is currently being stored.

A program running on the processor 110 may access a data object that is represented by a tree of chunks using multiple levels of indirection. For example, the program may start by accessing a root chunk of the tree, and may then follow the links represented by handles at various offsets within the successive chunks in the tree (using successive ChunkRread instructions), down to a data value in a leaf chunk. The data value in the leaf chunk can be uniquely identified either directly by its handle, or by the handle of the root chunk and a series of offset values within successive chunks. That is, the path to the data value uses successive values (e.g., 4-bit nibbles for chunks with 16 entries) that identify the successive offsets that the memory system traverses to act on ChunkRead and ChunkWrite instructions on a data object with a particular root chunk. For some data objects, such as the vector 4096-element array represented by the three-level tree of chunks described above, a data value within that data object can also be identified by a single offset into the array (e.g., a value from 1 to 4096), which is translated into the corresponding series of chunk offsets (i.e., 4-bit nibbles) needed to perform the corresponding series of ChunkRead instructions.

When a chunk to be accessed is present in a chunk buffer, each ChunkRead instruction (or each ChunkWrite instruction) should require only a relatively small number of processor cycles (e.g., a single processor cycle) to select the appropriate chunk buffer using the content of the index register and access the chunk element within that chunk buffer at the offset specified by the instruction. Accessing a chunk element in a chunk several levels from the root chunk of a data object may require several processor cycles, even if all of the chunk elements in the tree are present in chunk buffers. For single-cycle chunk buffer access, if the processor 110 is executing a program that is actively using a set of data objects and all chunks of the tree representations of those data objects have been loaded into chunk buffers, then the number of processor cycles used to access any data value of a balanced tree array data object is equal to the depth in the tree of the leaf chunk containing the data value. Two cycles will access any data value of a two-level tree containing 256 data values; three cycles will access any data value of a three-level tree containing 4096 data values, etc. If a handle is read for which the corresponding chunk is not present in a chunk buffer (e.g., as indicated by a validity bit for the index register corresponding to the CE register storing the handle), then a “miss” has occurred and the specified chunk is loaded into a chunk buffer by the controller 128. The replacement procedure that the controller 128 uses to search for the chunk using its handle may be performed in a blocking or non-blocking manner, depending on the anticipated time (i.e., number of processor cycles) needed for loading the chunk and the time-sensitivity of the part of the program being executed.

In some implementations, each level of memory includes a controller, which may be implemented using logic to handle the messages from higher and lower levels. For example, the level 1 memory 120 includes a controller 128 and the level 2 memory includes a controller 138.

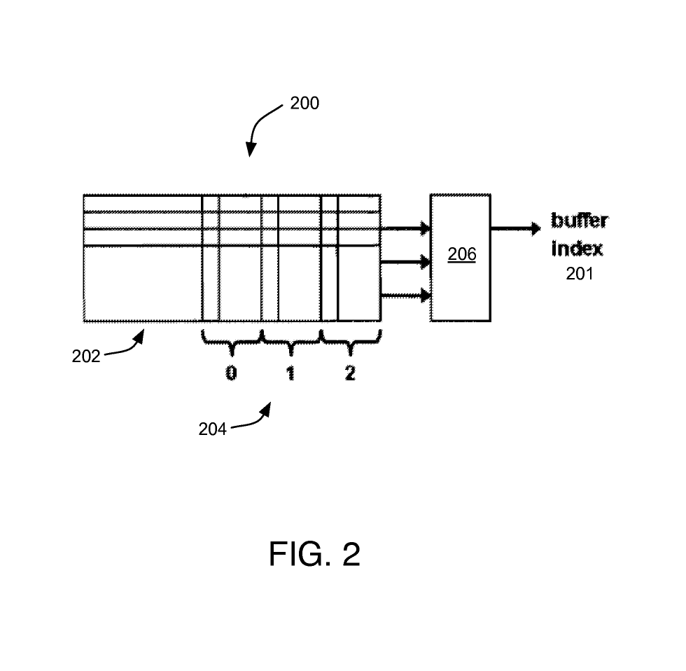

Referring to FIG. 2, in some implementations, a level 1 memory 120 uses an index map 200 to map a memory reference to a chunk element in a data object, given as a handle and an offset, directly to the index of the chunk buffer containing that chunk element without having to sequence through chunks on the path from the root chunk of that data object. The index map 200 can be implemented as an associative memory with a set of entries that can be searched for a match between one of the entries and a search key. The result of a search is the index 201 of the matching entry. The number of entries is the number M of chunk buffers. The search key consists of a primary field 202 and a sequence of offset nibbles 204. The primary field 202 is the index of the chunk buffer assigned to the root chunk of the object representation. The nibbles 204 are successive four-bit parts of the offset value (all but the last) that define the path to the chunk (leaf or non-leaf) held in the chunk buffer corresponding to the index map entry. Each entry also includes information that indicates how long a prefix of the nibble sequence is valid. Match logic circuitry 206 is configured to perform the search for the pair (index, offset) in the index map 200 gives the index of the entry that matches with the longest prefix of offset nibbles 204 (in this example 3 nibbles labeled 0, 1, 2). If the best match is with the complete key, then the index of the matching entry is the index of the chunk buffer containing the target chunk, and the access is completed using the four-bit offset given by the last nibble of the instruction offset field. If the best match is not to the complete offset value, the index selects a chunk buffer holding a non-leaf chunk on the path to the target leaf chunk (in which case, a miss has occurred). The index is then used to get the handle of the non-loaded chunk, non-leaf or leaf, needed to load the missing chunk and continue or complete the access.

If all leaf chunks of an object representation are present in chunk buffers, then every reference to a data element of the object will be completed with a single search of the index map 200, and use of the resulting index 201 to access a chunk buffer. This is readily completed within relatively few typical processor cycles (e.g., 2 cycles).

The index map 200 can be implemented, for example, using a specialized content addressable memory (CAM) in which the longest key has a length equal to the sum of the length of a buffer index and four less than the maximum length of the instruction offset field, and is independent of the size of the virtual memory address space (the space of all possible handles). This is small in comparison with the width of tags in conventional caches, especially if a 64-bit virtual address space is implemented. Other implementations of the index map 200 are also possible.

Note that it is possible to use an index map 200 that only supports search for a chunk specified by a short offset field, for example a 12-bit offset that supports three-level trees for objects having as many as 4096 data elements. Accesses to these elements would be completed in the minimum number of processor cycles. Accesses to data elements of a very large object, representing a huge sparse array, for example, may be implemented using two or more searches of the index map 200 and consume as many processor cycles.

The combination of chunk buffers and optional index map 200 may be applied to the memory level closest to the processing core (e.g., in place of a conventional L1 cache), and/or at lower levels (e.g., L2 or L3 cache) of the memory hierarchy. The techniques could also be applied to off-chip memory, for example, if a combination of DRAM and Flash memory units were used together to build the main memory.

Different implementation techniques would be appropriate at different memory system levels. Use of an index map 200 implemented by a hardware CAM may be most worthwhile at the L1 level, for example. At lower levels it may prove better to omit the index map 200 or use some kind of sequential search technique for its implementation.

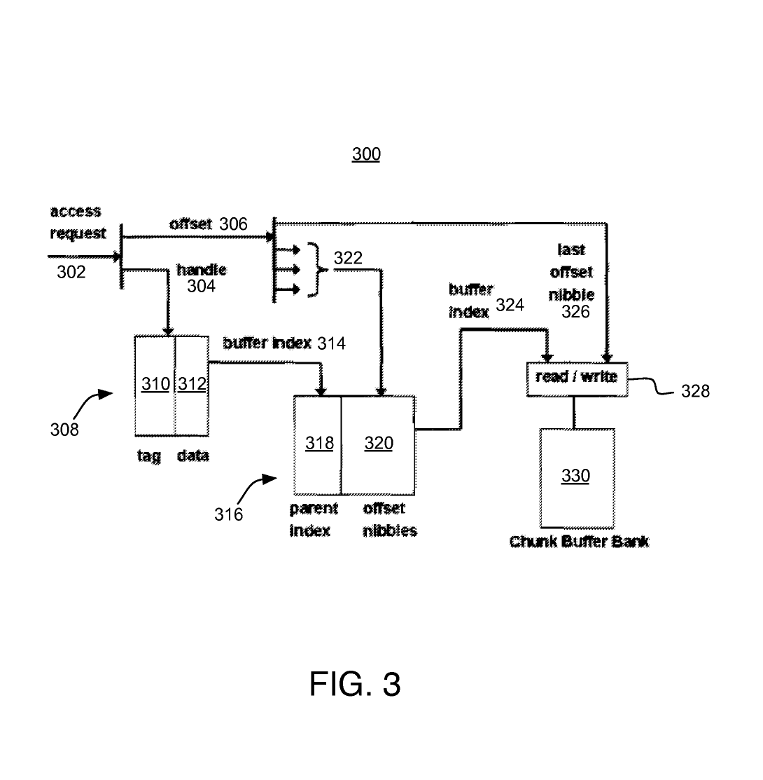

At memory system levels beyond L1 (e.g., for L2 or L3 memory levels), processor registers are typically not accessible, and/or the number of objects for which chunks are present will typically exceed the number of processor registers. In such cases, a means of identifying the chunk buffer allocated to the root chunk of an object may be needed. FIG. 3 shows an example non-register buffering system in 300, which receives an access request 302 (from a processor) with a handle 304 of a root chunk of a data object and an offset 306 of multiple nibbles specifying a path from that root chunk to a desired chunk in the data object. A handle CAM 308 includes a tag portion 310 and a data portion 312. A buffer index 314 represents a parent index input for accessing an index map 316, which includes a parent index portion 318 and an offset nibbles portion 320. The first set 322 of nibbles of the offset 306 represent the remaining input for accessing the index map 316, which produces an output that represents a buffer index 324 that is combined with the last nibble 326 of the offset 306 to access a read/write component 328. The read/write component 238 performs a desired read or write operation on the appropriate chunk buffer of a chunk buffer bank 330.

If an index map 200 is used, and all leaf chunks of data object have been loaded, full access to all data values in leaf chunks of the object may be performed with no need to access the non-leaf chunks in chunk buffers. These unneeded chunk buffers might be used for unrelated chunks, but their indices are committed. Some implementations trade off additional complexity to achieve better chunk buffer utilization by configuring the memory system to use an extra bit in chunk buffer indices so that each physical chunk buffer has two names. If one name is committed to an unneeded non-leaf chunk, the other can be used to select a new chunk.

In some computer systems, there is no notion of data objects in the hardware memory system, and instead there is simply a linear virtual address space. However, this address space may be viewed as a single very large data object and some of the principles of techniques presented above applied may still be applied. For example, if a virtual memory system uses a 32-bit address space, the contents of the virtual memory may be represented by a tree of chunks having a depth of eight—seven levels of non-leaf chunks and a level of leaf chunks. The memory space required for the non-leaf chunks is bounded by 1/15 of the memory space taken by the leaf chunks, which is not significantly greater than the page table of some conventional memory systems, which shares main memory with loaded pages. In the absence of any special hardware, accessing a data element in virtual memory using this representation would require eight main memory accesses—seven accesses of non-leaf chunks followed by a final access of the leaf chunk.

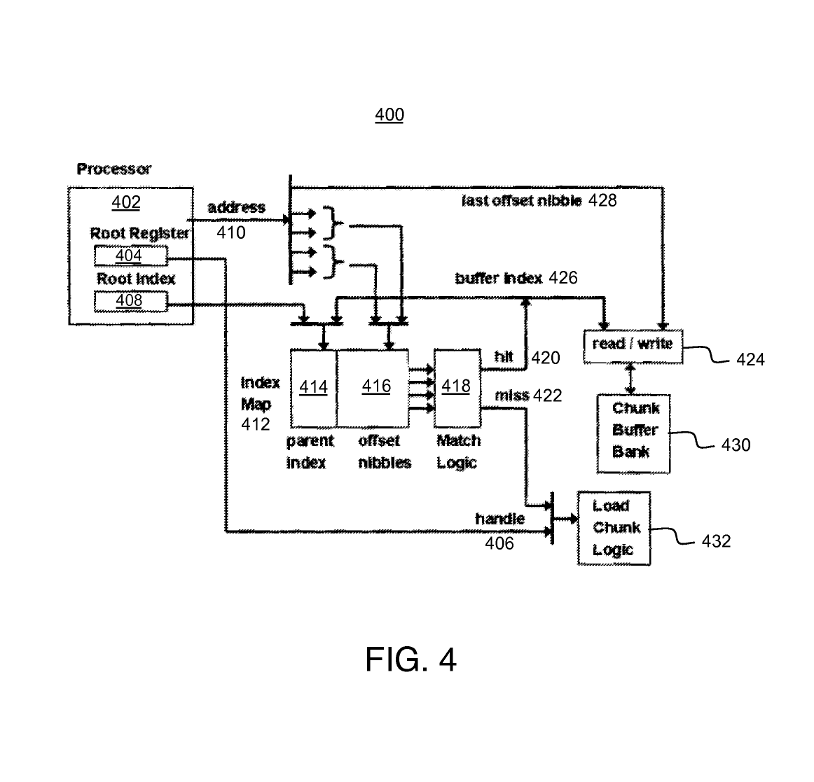

One example of applying the buffering techniques to such a linear address space memory system is shown in FIG. 4. In a linear address space buffering system 400, a processor 402 includes a special root register 404, which stores the handle 406 (i.e., virtual memory address) of the root chunk of the address space. (Note that multiple address spaces, for example for multiple processes, may be supported by resetting the root register 404.) The root register 404 has an associated root index register 408 that stores the index of the chunk buffer that stores the root chunk. Memory read and write instructions issued by the processor 402 specify virtual addresses, which are used to construct pairs consisting of a root index (stored in the root index register 408) and an offset address 410 (e.g., a sequence of nibbles identifying a path to a data value). An index map 412 includes a parent index portion 414 and an offset nibbles portion 416. Match logic circuitry 418 provides a hit output 420 in the case of a hit (i.e., a chunk buffer stores the chunk to be accessed), or a miss output 422 in the case of a miss (i.e., no chunk buffer stores the chunk to be accessed). In the case of a hit, a read/write component 424 performs a desired read or write operation on the appropriate chunk buffer of a chunk buffer bank 430, using a buffer index 426 and the corresponding last offset nibble 428. In the case of a miss, load chunk logic circuitry 432 performs a load procedure to load the desired chunk into a chunk buffer.

The index map 412 is useful for achieving fast hit access times. For example, consider a system in which two searches of the index map 412 are used for each virtual memory access. For a buffer system equivalent in size to an 8 KB L1 cache, 64 chunk buffers of 128 bytes are used, so a six-bit index field will suffice. Four nibbles (i.e., 16 bits) will serve to match half of a virtual address. Thus a 22-bit wide CAM of 64 entries will suffice. The techniques may be applied to a 64-bit address space, for example, using an index map 412 implemented using a CAM with a width of 38 bits to support access in two searches, or a 26-bit wide CAM for access in three searches.

It is to be understood that the foregoing description is intended to illustrate and not to limit the scope of the invention, which is defined by the scope of the appended claims. Other embodiments are within the scope of the following claims.

What is claimed is:

1. A computer processor, comprising:
an instruction processor configured to execute instructions in an instruction set, at least some of the instructions in the instruction set accessing chunks of memory in a memory system coupled to the computer processor; and
a plurality of storage locations, with at least some of the instructions each specifying a set of storage locations including:
a first storage location storing a unique identifier of a first chunk, and
a second storage location storing a reusable identifier of a storage area in the memory system storing the first chunk.

2. The computer processor of claim 1, wherein the plurality of storage locations comprise a first set of registers configured to store unique identifiers of chunks and a second set of registers configured to store reusable identifiers of storage areas storing chunks identified by the unique identifiers stored in the first set of registers, and wherein for at least some of the instructions, the first storage location comprises one of the plurality of registers of the first set, and the second storage location comprises one of the plurality of registers of the second set.

3. The computer processor of claim 2, wherein each register of the first set is associated with a tag that has at least two states, including at least one state that identifies that register as storing a unique identifier of a chunk, and at least one state that identifies that register as storing a data value.

4. The computer processor of claim 2, wherein each register of the second set is associated with a flag that identifies that register as storing a reusable identifier of a storage area that is currently storing a chunk identified by a unique identifier stored in a corresponding register in the first set.

5. The computer processor of claim 1, wherein the storage area is a storage area in a first memory level of the memory system.

6. The computer processor of claim 5, wherein the memory system includes the first memory level and a second memory level, the first memory level being configured as a buffer for chunks stored in the second memory level.

7. The computer processor of claim 1, wherein the storage area is one of a plurality of storage areas in the memory system.

8. The computer processor of claim 7, wherein the memory system includes control circuitry configured to assign a particular reusable identifier, from a set of reusable identifiers that have a one-to-one correspondence with the plurality of storage areas, to different unique identifiers based on which chunks are stored in the storage area corresponding to that particular reusable identifier.

9. The computer processor of claim 1, wherein the instruction set includes memory instructions for accessing chunks of memory, each including:
a first field specifying a set of storage locations including a storage location storing a unique identifier of a chunk; and
a second field specifying an element of the chunk identified by the unique identifier stored in a storage location specified by the first field.

10. A memory system comprising:
one or more memory levels, each memory level comprising storage areas for a plurality of chunks of memory;
wherein the memory system is configured to be responsive to memory messages in a message set from a processor coupled to the memory system, at least some of the messages including:
a first field identifying a unique identifier of a first chunk stored in a storage area of a first memory level of the memory system, and
a second field identifying a reusable identifier of the storage area.

11. The memory system of claim 10, further comprising control circuitry configured to search for a second chunk in a second memory level in response to the second storage location in the processor being tagged as not storing a valid reusable identifier of a storage area of the first memory level currently storing the second chunk.

12. The memory system of claim 10 wherein the memory system is configured to maintain a linkage among a plurality of chunks via unique identifiers stored in elements of the chunks.

13. The memory system of claim 10, wherein the memory system includes the first memory level and a second memory level, the first memory level being configured as a buffer for chunks stored in the second memory level.

14. The memory system of claim 10, wherein the storage area is one of a plurality of storage areas of the first memory level of the memory system.

15. The memory system of claim 14, further comprising control circuitry configured to assign a particular reusable identifier, from a set of reusable identifiers that have a one-to-one correspondence with the plurality of storage areas, to different unique identifiers based on which chunks are stored in the storage area corresponding to that particular reusable identifier.

16. A computing system comprising:
one or more processors; and
a memory system including one or more first level memories, each first level memory coupled to a corresponding one of the processors;
wherein each processor is configured to execute instructions in an instruction set, at least some of the instructions in the instruction set accessing chunks of memory in the memory system, and each processor includes a plurality of storage locations, with at least some of the instructions each specifying a set of storage locations including:
a first storage location in a first of the processors storing a unique identifier of a first chunk, and
a second storage location in the first processor storing a reusable identifier of a storage area in the corresponding first level memory storing the first chunk.

17. The computing system of claim 16, wherein each of the first level memories includes
storage areas for one or more chunks, each chunk having the same number of elements, each element being configured for storing either a unique identifier of a chunk or a data value;
wherein the memory system is configured to be responsive to memory messages in a message set from the processors, at least some of the messages including:
a first field including a unique identifier of a chunk, and
a second field including a reusable identifier of a storage area storing the chunk identified by the unique identifier.

18. The computing system of claim 17, wherein at least some of the messages further include a third field including a memory address specifying a data element in an address space of the memory system.

19. The computing system of claim 18, wherein at least some of the instructions each include:
a first field specifying the set of storage locations including the first storage location and the second storage location, and
a second field including a memory address specifying a data element in the address space.

20. The computing system of claim 19, wherein the address space includes a plurality of distinct address space pages, each page corresponding to a chunk, and each page having the same number of elements as the number of elements in a chunk, and each element of a page being configured for storing either a unique identifier of a chunk or a data value.

21. The computing system of claim 20, wherein a memory address included in the third field of a message or the second field of an instruction is represented as a first sequence of address nibbles, a second sequence of address nibbles forms an address prefix that includes all address nibbles in the first sequence except for the last address nibble in the first sequence, and the last address nibble in the first sequence comprises a chunk offset identifying an element of a chunk.

22. The computing system of claim 21, wherein an address nibble includes a sufficient set of bits to uniquely select an element of a chunk.

23. The computing system of claim 21, wherein each first level memory includes control circuitry configured to store associations of members of a set of one or more memory keys with members of a set of reusable identifiers of memory storage areas, and each memory key includes at least a first field including a first buffer index of a storage area, and a second field including a sequence of two or more address nibbles of the memory address.

24. The computing system of claim 23, wherein the address nibbles of the memory address except for the last nibble of the sequence together select a page in the address space storing the chunk identified by the unique identifier stored in a storage location specified by the first field, and the last nibble of the sequence comprises a chunk offset identifying an element of the chunk stored in the page.

25. The computing system of claim 16, wherein at least some of the instructions each include:
a first field specifying a set of storage locations including a storage location storing a unique identifier of a chunk, and
a second field specifying an element of the chunk identified by the unique identifier stored in a storage location specified by the first field.

26. The computing system of claim 16 wherein the plurality of storage locations in each of the processors comprises a first set of registers configured to store unique identifiers of chunks and a second set of registers configured to store reusable identifiers of storage areas storing chunks identified by the unique identifiers stored in the first set of registers, and wherein for at least some of the instructions, the first storage location comprises one of the plurality of registers of the first set, and the second storage location comprises one of the plurality of registers of the second set.

27. A non-transitory computer-readable medium comprising instructions for causing a circuit design system to form a circuit description for the computer processor of claim 1.

28. A non-transitory computer-readable medium comprising instructions for causing a circuit design system to form a circuit description for the memory system of claim 10.
